(19) United States
(12) Patent Application Publication
(10) Pub. No.: US 2025/0337456 A1
(43) Pub. Date: Oct. 30, 2025

(54) METHOD FOR DETECTING THE PRESENCE OF AN NFC TRANSPONDER

(71) Applicant: Schaeffler Technologies AG & Co. KG, Herzogenaurach (DE)

(72) Inventors: Michele CIOCCHETTA, Toulouse (FR); Mark MINARIK, Trutnov (CZ); Milan LESAK, Trutnov (CZ)

(21) Appl. No.: 19/191,812

(22) Filed: Apr. 28, 2025

(30) Foreign Application Priority Data
Apr. 29, 2024 (FR) 2404436

(51) Int. Cl. H04B 5/45; B60R 25/24

(52) U.S. Cl. CPC H04B 5/45; B60R 25/24; B60R 2325/103

(57) ABSTRACT

A method implemented in a near-field communication system (100), for detecting the presence of a radio-frequency transponder (110) by means of a radio-frequency reader (120) on board a motor vehicle, said radio-frequency transponder (110) being carried in use by a user located outside the vehicle, and said radio-frequency reader (120) being intended to communicate with the radio-frequency transponder (110) so as to control access to the motor vehicle, the method comprising the following steps implemented by the radio-frequency reader:
transmitting a radio-frequency interrogation signal; then
transmitting a radio-frequency supply signal, intended to be received then modulated by the radio-frequency transponder;
detecting the presence of the radio-frequency transponder (110) by measuring an amplitude of the radio-frequency supply signal and comparing it with at least one predetermined threshold.

### TECHNICAL FIELD

The invention relates to the field of automobiles and more particularly to the field of near-field communication (NFC) systems allowing data exchange between a transponder carried by a user and an on-board system for managing access to the vehicle.

### PRIOR ART

Near-field communication systems intended for use in the automotive field are known in the prior art, with a view to authorizing or not authorizing access to the vehicle depending on the identity of the approaching user.

Such a system comprises in particular a radio-frequency reader, on board the motor vehicle in use, and a radio-frequency transponder, carried in use by a user located outside the vehicle and integrated into a badge or a smartphone. The radio-frequency reader is configured to interrogate the radio-frequency transponder so as to obtain at least one authentication code stored therein. This authentication code is transmitted to a vehicle access management system which determines whether or not the radio-frequency transponder is authorized to access the vehicle. Depending on the vehicle access authorizations stored in the access management system, at least one vehicle access command is generated or not, preferably a command for locking or unlocking at least one opening element of the vehicle and/or a command for opening or closing at least one opening element of the vehicle and/or a command for opening or closing at least one window of the vehicle.

In a manner known per se, the method implemented at the radio-frequency reader comprises an initial step of detecting the presence of a radio-frequency transponder, by transmitting short-duration pulses dedicated to said detection and measuring the possible influence of a radio-frequency transponder located in the vicinity of the radio-frequency reader. This presence detection is known as LPCD detection, standing for “Low Power Card Detection”.

Once the presence of a radio-frequency transponder has been detected in the vicinity of the radio-frequency reader, the radio-frequency reader transmits a radio-frequency interrogation signal, modulated and forming a request to read data from the radio-frequency transponder. Various modulations may be implemented: amplitude and/or phase and/or frequency modulation. In particular, various amplitude modulation solutions are known, characterized by a waveform (shape of the non-modulated signal, for example a continuous signal, or a square wave, or any other shape) and a ratio between the maximum peak-to-peak amplitude (encoding a bit of value equal to unity) and the minimum peak-to-peak amplitude (encoding a zero-value bit).

After that, the radio-frequency reader transmits a radio-frequency power signal, intended to be received by the radio-frequency transponder. Specifically, the radio-frequency reader is configured to be able to communicate with any type of radio-frequency transponder, whether active or passive. An active radio-frequency transponder comprises an energy source for generating a response signal, sent in response to receiving the radio-frequency interrogation signal. A passive radio-frequency transponder, on the other hand, does not comprise such an energy source. In order to transmit data, it may only modulate a signal that it receives, in this case said radio-frequency supply signal.

In any event, as of the transmission of the radio-frequency supply signal, the radio-frequency reader normally receives a return signal modulated by the radio-frequency transponder. It may thus be a signal generated by the passive transponder, or the radio-frequency supply signal influenced, in other words modulated, by the radio-frequency transponder.

The radio-frequency supply signal is a continuous signal which has a constant amplitude in the absence of influence by the environment and in particular by the radio-frequency transponder. The radio-frequency supply signal is commonly referred to as the “FWI” frame, standing for “Frame Waiting time Integer”. The term “FWI” also refers to an integer whose value defines the FWT (Frame Waiting Time) duration of the “FWI” frame. In particular, FWI takes a value between 0 and 14, preferably 4. The FWT duration is defined by: FWT=(256*16/f_{c})*2^{FWI}, where f_{c} is the carrier frequency of the radio-frequency signal. The FWT duration is generally between 300 μs and 5 s.

The near-field communication between the radio-frequency reader and the radio-frequency transponder advantageously consists of an alternation of radio-frequency interrogation signals and radio-frequency supply signals.

It may happen that the radio-frequency transponder leaves the environment close to the radio-frequency reader while the communication process is in progress, i.e. after the radio-frequency power signal has been transmitted. In this case, the radio-frequency reader must wait for the entire predetermined duration of the radio-frequency supply signal (FWI frame), then implement a process to confirm a timeout error when the radio-frequency reader has not received any modulated return signal for the entire duration of this TWI frame.

This process of confirming a timeout error consists in:
sending a new specific interrogation signal,
waiting for a response for a predetermined time with transmission of a supply signal for this waiting time, and
repeating these operations several times until a valid response is finally received from the radio-frequency transponder or until a predetermined number of unsuccessful attempts has been reached.

In the second case where the predetermined number of attempts has been reached without receiving any valid response, a timeout error is generated on the radio-frequency reader side, which terminates the communication initiated between the radio-frequency reader and the transponder. This process of confirming a timeout error may last several seconds, for example 5×4.95s≅25 s for a number of attempts equal to 5 and an FWT duration as defined above equal to 4.95s. Furthermore, this process involves, for all this time, a radio-frequency signal transmission which consumes energy.

It may also happen that the radio-frequency transponder leaves the environment close to the radio-frequency reader before the communication process has even started. In this case, the process is about the same, with implementation of a process of confirming a time-out error, which takes time and consumes energy.

An objective of the present invention is to propose a faster and more energy-efficient solution for managing a situation in which the radio-frequency reader receives no modulated return signal for the entire duration of transmission of the radio-frequency supply signal (FWI frame).

### DISCLOSURE OF THE INVENTION

This objective is achieved with a method implemented in a near-field communication system, for detecting the presence of a radio-frequency transponder by means of a radio-frequency reader on board a motor vehicle, said radio-frequency transponder being carried in use by a user located outside the vehicle, and said radio-frequency reader being intended to communicate with the radio-frequency transponder so as to control access to the motor vehicle, the method comprising the following steps implemented by the radio-frequency reader:
transmitting a radio-frequency interrogation signal, modulated and forming a request to read data from the radio-frequency transponder; then
transmitting a radio-frequency supply signal, intended to be received then modulated by the radio-frequency transponder for the transmission of the data requested by the radio-frequency interrogation signal.

According to the invention, the method further comprises a step of detecting the presence of the radio-frequency transponder by measuring an amplitude of the radio-frequency supply signal and comparing it with at least one predetermined threshold.

Advantageously, but not limitingly, this presence detection step is started at the same time as the step of transmitting a radio-frequency supply signal, so as to be able to detect as soon as possible that the radio-frequency transponder has left the near field of the radio-frequency reader.

The method according to the invention proposes a solution for confirming the presence or not of the radio-frequency transponder, more quickly and more precisely than using the steps of confirming a time-out error, as described above.

It may happen that the radio-frequency transponder does not react to the radio-frequency supply signal but that it is still present in the environment of the radio-frequency reader. This is the case, for example, in the case of electromagnetic disturbances in the near field of the radio-frequency reader, or if the radio-frequency transponder is incorrectly positioned, or else if the radio-frequency transponder is of the active type and lacks energy to transmit a response signal. The invention exploits the fact that, in such a situation where the radio-frequency transponder does not react to the radio-frequency supply signal while being present in the environment of the radio-frequency reader, it will have an influence on the amplitude of said radio-frequency supply signal. Measuring this amplitude and comparing it with at least one predetermined threshold thus make it possible to obtain information on the presence or not of the radio-frequency transponder in the vicinity of the radio-frequency reader. This may thus confirm, or deny, a suspicion that the radio-frequency transponder has left the immediate environment of the radio-frequency reader.

Throughout the text, the notion of immediate environment refers to the range of a radio-frequency reader of a near-field communication (NFC) system, i.e. a radius of a few centimeters, for example less than ten centimeters around the radio-frequency reader.

One of the tricks of the method according to the invention consists in exploiting, for the presence detection, a radio-frequency signal necessarily transmitted following the transmission of the radio-frequency interrogation signal: the radio-frequency supply signal (or FWI frame, as described in the introduction). Implementing the method therefore does not require any substantial modification of the existing one. Furthermore, since the radio-frequency signal used for the presence detection is a non-modulated signal (in the absence of a radio-frequency transponder in the vicinity of the radio-frequency reader), the detection of a change in amplitude is particularly easy to implement.

The method according to the invention thus proposes a solution for confirming the presence or not of the radio-frequency transponder, more quickly and more precisely than using the steps of confirming a time-out error, as described above. Furthermore, the method according to the invention is particularly energy-efficient since it does not require any additional signal transmission. Provided that this is permitted by the standards in force, it could then be envisaged to dispense with the procedure described in the introduction, which is both long and energy-intensive since it requires several signal transmission cycles by the radio-frequency reader, and thus drastically reduce the power consumption of the near-field communication system.

Preferably, the presence detection comprises measuring the amplitude of the radio-frequency supply signal and comparing it with a value of the amplitude of the radio-frequency supply signal in the absence of a radio-frequency transponder, called the no-load value.

Advantageously, the presence of the radio-frequency transponder is detected when a deviation between the measured value of the amplitude of the radio-frequency supply signal and said no-load value is greater than a predetermined deviation threshold.

As a variant, the presence of the radio-frequency transponder may be detected when a ratio between the measured value of the amplitude of the radio-frequency supply signal and said no-load value is less than a predetermined ratio threshold.

According to another variant, the presence of the radio-frequency transponder may be detected when a ratio between a deviation between the measured value of the amplitude of the radio-frequency supply signal and said no-load value, on the one hand, and said no-load value, on the other hand, is less than a predetermined ratio threshold.

Preferably, the amplitude of the radio-frequency supply signal remains greater than or equal to half the no-load value, even in the presence of the radio-frequency transponder.

The radio-frequency supply signal advantageously has a constant amplitude in the absence of a radio-frequency transponder.

The radio-frequency supply signal may have a duration of between 250 microseconds and 6 seconds.

The method according to the invention is advantageously implemented with a radio-frequency transponder of passive type.

Preferably, the signal transmission by the radio-frequency reader is suspended when the absence of the radio-frequency transponder is detected at the end of the step of detecting the presence of the radio-frequency transponder.

The method may also comprise receiving a return radio-frequency signal, corresponding to the radio-frequency supply signal modulated by the radio-frequency transponder, and containing authentication information of the radio-frequency transponder intended to be used to authorize access to the motor vehicle or not.

The invention also relates to the use of the method according to the invention, which is implemented after a first changeover from a locked or unlocked state of at least one opening element of the motor vehicle, or a changeover from an open or closed state of at least one opening element of the motor vehicle, or a changeover from an open or closed state of at least one window of the motor vehicle, in response to authentication of the radio-frequency transponder, in which method a new changeover from this state is authorized only if the absence of said radio-frequency transponder has been detected at the end of the step of detecting the presence of the radio-frequency transponder.

The invention also relates to the use of the method according to the invention, which is implemented to detect a back and forth movement of the radio-frequency transponder relative to the radio-frequency reader, said movement being associated with a command to change over from a locked or unlocked state of at least one opening element of the motor vehicle, or to change over from an open or closed state of at least one opening element of the motor vehicle, or to change over from an open or closed state of at least one window of the motor vehicle.

Finally, the invention covers a radio-frequency reader intended to be on board a motor vehicle for communication with a radio-frequency transponder carried in use by a user located outside the vehicle, said radio-frequency reader being intended to communicate with the radio-frequency transponder so as to control access to the motor vehicle, and being configured to implement the steps of the method according to the invention.

### DESCRIPTION OF THE FIGURES

Further features and advantages of the invention will become more apparent upon reading the following description. This description is purely illustrative and should be read with reference to the appended drawings, in which:

FIG. 1 schematically illustrates a near-field communication system in which a presence detection method according to the invention is implemented;

FIG. 2 schematically illustrates the steps of a method according to the invention; and

FIG. 3 schematically illustrates the amplitude as a function of time, of a radio-frequency signal transmitted by a radio-frequency reader implementing a method according to the invention.

### DETAILED DESCRIPTION OF AT LEAST ONE EMBODIMENT

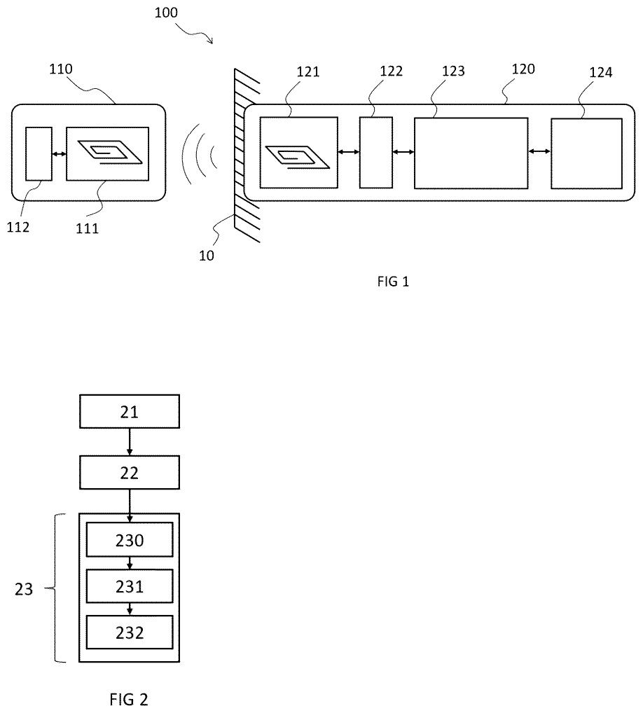

A description is first of all given, with reference to FIG. 1, of a near-field communication system 100 in which a presence detection method according to the invention is implemented.

The system 100 consists of a radio-frequency transponder 110 and a radio-frequency reader 120.

The term “near-field communication” refers to a short-range, high-frequency wireless communication technology (preferably between 5 MHz and 20 MHz, for example about 14 MHz), enabling the exchange of information between devices (here the radio-frequency transponder 110 and the radio-frequency reader 120) up to a distance of about ten centimeters. Near-field communication preferably follows standards known by the abbreviation NFC.

In use, the radio-frequency reader 120 is on board a motor vehicle (FIG. 1 schematically shows the interface 10 between the vehicle and its external environment).

The radio-frequency reader 120 comprises in particular at least one antenna 121, a matching circuit 122, a signal pre-processing chip 123, and a microcontroller 124 connected together in this order.

The radio-frequency antenna 120, called the NFC antenna 121, is positioned in use in the vicinity of an external surface of the vehicle, for example at a door handle or a vertical structural pillar located between a front door and a rear door. The NFC antenna 121 is configured to transmit and receive a radio-frequency signal, in particular a near-field communication signal.

The matching circuit 122 is configured to perform impedance matching between the impedance of the NFC antenna 121 and the impedance of the circuits on the signal pre-processing chip 123. The matching circuit 122 advantageously comprises at least two metal tracks which extend on a printed circuit board each between a respective end of the NFC antenna 121 and the signal pre-processing chip 123.

The signal pre-processing chip 123 comprises a clock at the frequency of the radio-frequency signal to be transmitted, for generating an electrical signal intended to be sent to the input of the NFC antenna 121. The signal pre-processing chip 123 also comprises two mixers, each configured to mix a signal received by the NFC antenna 121 with the clock signal in phase, or in phase quadrature, so as to obtain a signal I and a signal Q. The signal pre-processing chip 123 also comprises at least one analog-to-digital converter for carrying out a temporal sampling of a signal.

The signal pre-processing chip 123 is configured to supply said temporally sampled signals I and Q to the microcontroller 124. The microcontroller 124 is configured to perform the analysis of said signals so as to extract amplitude and/or phase and/or frequency data, and to implement a method as described below.

The amplitude and/or phase and/or frequency data may encode authentication information which may be extracted directly within the microcontroller 124, or within a remote computer (not shown).

In use, the radio-frequency transponder 110 is carried by a user, in particular a user located outside the vehicle and wishing to access said vehicle. The radio-frequency transponder 110 may take the form of a dedicated badge or “keyfob”, or be an integral part of a smartphone. The radio-frequency transponder 110 comprises at least one NFC antenna 111 and a memory 112.

The NFC antenna 111 is configured to perform near-field communication with the antenna 121 of the radio-frequency reader 120. The memory 112 advantageously stores at least one authentication datum.

The system 100 comprising the radio-frequency transponder 110 and the radio-frequency reader 120 belong to a motor vehicle access system configured to authorize access to the vehicle only to users having an authorized radio-frequency transponder 110. More particularly, the near-field communication system 100 is configured, in use, to perform near-field communication, by way of the radio-frequency reader 120, between the radio-frequency transponder 110 and a computer forming a vehicle access management system, configured to compare an authentication code stored in the radio-frequency transponder 110 and communicated via the radio-frequency reader 120, with an authentication code associated with at least one authorized transponder and stored in a memory of a vehicle access system. When the authentication codes coincide, the vehicle access management system generates at least one vehicle access command, preferably a command for locking or unlocking at least one opening element of the vehicle and/or a command for opening or closing at least one opening element of the vehicle and/or a command for opening or closing at least one window of the vehicle. Throughout the text, the opening element refers to a front or rear trunk door or tailgate or a front or rear trunk opening element.

Advantageously, but not limitingly, the radio-frequency transponder 110 is of passive type. This means that it does not comprise an energy source allowing it to generate a radio-frequency signal itself. It transmits information by modifying a radio-frequency signal generated by the radio-frequency reader 120. In particular, the radio-frequency transponder 110 is then configured to modulate a radio-frequency signal supplied by the radio-frequency reader 120, so as to encode a datum such as an authentication datum. The modulation is advantageously amplitude modulation.

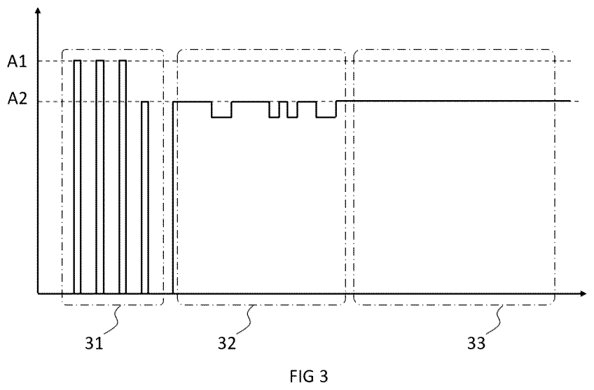

The steps of a method according to the invention will now be described with reference to FIGS. 2 and 3.

FIG. 2 illustrates more particularly the steps of a method according to the invention, implemented in a near-field communication system 100.

FIG. 3 illustrates more particularly, and schematically, the evolution as a function of time of the amplitude of a radio-frequency signal transmitted by the radio-frequency reader 120.

In a preliminary step, and in a manner known per se, the radio-frequency reader 120 performs presence detection called Low Power Card Detection, or LPCD. This presence detection consists in transmitting very short radio-frequency pulses, spaced in time, and in identifying a modification of at least one parameter among the amplitude, the phase and the frequency indicating the presence of a radio-frequency transponder 110 in the near field (in practice, a radius of ten centimeters or less) of the radio-frequency reader 120. In FIG. 3, the LPCD pulses correspond to the signal portion 31, and the input of the radio-frequency transponder 110 into the near field of the radio-frequency reader 120 is marked by a modification of the amplitude of the pulses (passage from an amplitude A1 to an amplitude A2).

In response to this presence detection, the radio-frequency reader 120 changes over from a standby mode to an active mode, and starts near-field communication with the radio-frequency transponder 110.

In a first step 21 of this communication, the radio-frequency reader 120 transmits a radio-frequency interrogation signal 32 forming a request for data from the radio-frequency transponder 110. As detailed in the introduction, various modulations may be implemented: amplitude and/or phase and/or frequency modulation. FIG. 3 illustrates more particularly the example of amplitude modulation. As explained in the introduction, and in a manner known per se, the amplitude modulation is characterized by a waveform, and by a ratio between the maximum peak-to-peak amplitude (encoding a bit of value equal to unity) and the minimum peak-to-peak amplitude (encoding a zero-value bit).

In a second step 22 of this communication, the radio-frequency reader 120 transmits a non-modulated radio-frequency supply signal 33. The radio-frequency supply signal 33 is intended to be received then modulated (in amplitude and/or phase and/or frequency) by the radio-frequency transponder 110, for the transmission of the data requested by the radio-frequency interrogation signal, preferably authentication data.

The radio-frequency supply signal 33 is matched to a radio-frequency transponder of passive type. However, whether the radio-frequency transponder 110 is passive or active, the radio-frequency reader 120 transmits such a radio-frequency supply signal after a sequence of transmission of a radio-frequency interrogation signal. As detailed in the introduction, the radio-frequency supply signal 33 is also known as the “FWI frame”.

According to the invention, step 22 is followed by a step 23 of detecting the presence of the radio-frequency transponder 110 by measuring an amplitude of the radio-frequency supply signal 33 and comparing it with at least one predetermined threshold.

In other words, said presence detection step 23 comprises a step 230 of measuring an amplitude of the radio-frequency supply signal, a step 231 of comparing a quantity which is a function of said measured amplitude with a predetermined threshold, and finally, a step 232 of determining the presence or absence of the radio-frequency transponder 110 in the near field of the radio-frequency reader 120.

These steps are implemented by the microcontroller 124 of the radio-frequency reader 120.

Advantageously, the presence detection step 23 starts at the same time as the step 22 of transmitting the radio-frequency supply signal, so as to detect the absence of the radio-frequency transponder as soon as possible. This rapid presence detection is particularly advantageous, in particular in a use of the method for detecting one or more back and forth movements of the radio-frequency transponder relative to the radio-frequency reader (one or more tappings). Such a movement may control a function of the vehicle, in particular a function for accessing the vehicle such as those described above (locking, unlocking, opening an opening element, closing an opening element, opening a window, closing a window).

The radio-frequency supply signal 33 has a duration of between 250 microseconds and 6 seconds. The predetermined threshold may be of the order of half this duration, for example between 100 microseconds and 3 seconds.

The method according to the invention thus proposes to perform presence detection as soon as possible. When the communication standards allow it, this may avoid unnecessary signal transmissions by the radio-frequency reader 120 and the associated power consumption. In particular, it is proposed to cleverly exploit the fact that the radio-frequency supply signal 33 is a non-modulated signal, the amplitude of which is therefore affected mainly by the presence or not of the radio-frequency transponder 110 in the near field of the radio-frequency reader 120. In other words, the radio-frequency supply signal 33 has a constant amplitude in the absence of a radio-frequency transponder. Its amplitude may be affected by amplitude modulation controlled by the radio-frequency transponder 110, or by the simple presence of the radio-frequency transponder in the absence of modulation by the latter.

Advantageously, the presence detection comprises measuring the amplitude of the radio-frequency supply signal and comparing it with a value of the amplitude of the radio-frequency supply signal in the absence of a radio-frequency transponder, called the no-load value.

The presence of the radio-frequency transponder 110 in the near field of the radio-frequency reader 120 modifies the amplitude of the radio-frequency supply signal measured with respect to its no-load value, in the absence of a radio-frequency transponder 110 in the near field of the radio-frequency reader 120. The presence of the radio-frequency transponder 110 in the near field of the radio-frequency reader 120 may be detected on the basis of a difference in absolute value, or deviation, between the measured amplitude and the amplitude at no load. As a variant, the presence of the radio-frequency transponder 110 in the near field of the radio-frequency reader 120 may be detected on the basis of a ratio between the measured amplitude and the amplitude at no load. It is also possible to use a ratio between said deviation and the amplitude at no load. One or the other of these criteria will advantageously be chosen by the person skilled in the art, as a function of the expected deviation, of the amplitude at no load, and so as to minimize a false detection rate.

In any event, the influence of the presence of the radio-frequency transponder 110 on the amplitude of the radio-frequency supply signal remains relatively small. In particular, the amplitude of the radio-frequency supply signal 33 remains greater than or equal to half, and even 80%, of its value at no load, even in the presence of the radio-frequency transponder 110.

Advantageously but optionally, when the absence of the radio-frequency transponder 110 in the near field of the radio-frequency reader 120 is detected in step 23, the signal transmission by said radio-frequency reader is suspended, the latter even being able to change over to standby mode again. Power consumption of the radio-frequency reader 120 is thus minimized, this having a definite advantage in the case of an element on board a motor vehicle.

On the other hand, when the presence of the radio-frequency transponder 110 in the near field of the radio-frequency reader 120 is detected in step 23, the method then advantageously comprises receiving a return radio-frequency signal, corresponding to the radio-frequency supply signal 33 modulated by the radio-frequency transponder 110 or to a radio-frequency signal generated by the active transponder. The return radio-frequency signal contains an authentication code of the radio-frequency transponder 110 intended to be extracted and analyzed by the vehicle access management system described above to authorize access to the motor vehicle or not. In particular, what is authorized, or not, is at least one action among a locking or unlocking of at least one opening element of the vehicle, an opening or closing of at least one opening element of the vehicle, an opening or closing of at least one window of the vehicle.

The invention finds a particularly advantageous application for confirming rapidly and with little signal that the radio-frequency transponder 110 has left the near field of the radio-frequency reader 120, after a first changeover from the locking or unlocking state of at least one opening element of the motor vehicle (to pass from a locked state to an unlocked state, or vice versa), or from the open or closed state of at least one opening element of the motor vehicle (to pass from an open state to a closed state, or vice versa), or from the open or closed state of at least one window of the motor vehicle (to pass from an open state to a closed state, or vice versa). It is a matter of authorizing a new changeover from this state only if the absence of the radio-frequency transponder 110 has been detected in the meantime. In other words, a new changeover from this state is authorized only if it is confirmed that the radio-frequency transponder 110 has left the near field of the radio-frequency reader 120 since the previous changeover. The objective is to avoid untimely state changeovers, with several successive state changes while the radio-frequency transponder 110 has not left the near field of the radio-frequency reader 120.

The invention thus proposes a solution for detecting the presence of an external NFC device (the radio-frequency transponder 110) without it being necessary to wait for the end of the communication.

One of the objectives is to authorize a new communication with the same external NFC device (the radio-frequency transponder 110), and thus a new changeover, in particular locked or unlocked of at least one opening element of the motor vehicle, only if said external NFC device has left the near field of the NFC reader (radio-frequency reader 120) in the meantime.

1. A method implemented in a near-field communication system (100), for detecting the presence of a radio-frequency transponder (110) by means of a radio-frequency reader (120) on board a motor vehicle, said radio-frequency transponder (110) being carried in use by a user located outside the vehicle, and said radio-frequency reader (120) being intended to communicate with the radio-frequency transponder (110) so as to control access to the motor vehicle, the method comprising the following steps implemented by the radio-frequency reader:
transmitting (21) a radio-frequency interrogation signal (32), modulated and forming a request to read data from the radio-frequency transponder (110); then
transmitting (22) a radio-frequency supply signal (33), intended to be received then modulated by the radio-frequency transponder (110) for the transmission of the data requested by the radio-frequency interrogation signal;
wherein it further comprises a step (23) of detecting the presence of the radio-frequency transponder (110) by measuring an amplitude of the radio-frequency supply signal and comparing it with at least one predetermined threshold.

2. The method as claimed in claim 1, wherein the presence detection (23) comprises measuring the amplitude of the radio-frequency supply signal (33) and comparing it with a value of the amplitude of the radio-frequency supply signal in the absence of a radio-frequency transponder, called the no-load value.

3. The method as claimed in claim 2, wherein the presence of the radio-frequency transponder (110) is detected when a deviation between the measured value of the amplitude of the radio-frequency supply signal (33) and said no-load value is greater than a predetermined deviation threshold.

4. The method as claimed in claim 2, wherein the presence of the radio-frequency transponder (110) is detected when a ratio between the measured value of the amplitude of the radio-frequency supply signal and said no-load value is less than a predetermined ratio threshold.

5. The method as claimed in claim 2, wherein the presence of the radio-frequency transponder (110) is detected when a ratio between a deviation between the measured value of the amplitude of the radio-frequency supply signal (33) and said no-load value, on the one hand, and said no-load value, on the other hand, is less than a predetermined ratio threshold.

6. The method as claimed in claim 1, wherein the amplitude of the radio-frequency supply signal (33) remains greater than or equal to half the no-load value, even in the presence of the radio-frequency transponder (110).

7. The method as claimed in claim 1, wherein the radio-frequency supply signal (33) has a constant amplitude in the absence of a radio-frequency transponder (110).

8. The method as claimed in claim 7, wherein the radio-frequency supply signal (33) has a duration of between 250 microseconds and 6 seconds.

9. The method as claimed in claim 1, wherein it is implemented with a radio-frequency transponder (110) of passive type.

10. The method as claimed in claim 1, wherein the signal transmission by the radio-frequency reader (120) is suspended when the absence of the radio-frequency transponder (110) is detected at the end of the step (23) of detecting the presence of the radio-frequency transponder (110).

11. The method as claimed in claim 1, wherein it further comprises receiving a return radio-frequency signal, corresponding to the radio-frequency supply signal (33) modulated by the radio-frequency transponder (110), and containing authentication information of the radio-frequency transponder (110) intended to be used to authorize access to the motor vehicle or not.

12. The use of the method as claimed in claim 1, implemented after a first changeover from a locked or unlocked state of at least one opening element of the motor vehicle, or a changeover from an open or closed state of at least one opening element of the motor vehicle, or a changeover from an open or closed state of at least one window of the motor vehicle, in response to authentication of the radio-frequency transponder (110), in which method a new changeover from this state is authorized only if the absence of said radio-frequency transponder (110) has been detected at the end of the step (23) of detecting the presence of the radio-frequency transponder (110).

13. The use of the method as claimed in claim 1, implemented to detect a back and forth movement of the radio-frequency transponder (110) relative to the radio-frequency reader (120), said movement being associated with a command to change over from a locked or unlocked state of at least one opening element of the motor vehicle, or to change over from an open or closed state of at least one opening element of the motor vehicle, or to change over from an open or closed state of at least one window of the motor vehicle.

14. A radio-frequency reader (120) intended to be on board a motor vehicle for communication with a radio-frequency transponder (110) carried in use by a user located outside the vehicle, said radio-frequency reader (120) being intended to communicate with the radio-frequency transponder (110) so as to control access to the motor vehicle, and being configured to implement the steps of the method as claimed in claim 1.
